(19) United States
(12) Patent Application Publication
(10) Pub. No.: US 2024/0055759 A1
(43) Pub. Date: Feb. 15, 2024

(54) INTEGRATED CONTROL METHOD FOR PLURALITY OF BEAMFORMING ANTENNAS

(71) Applicant: RFCORE CO.,LTD., Gyeonggi-do (KR)

(72) Inventor: Yong-Jun KIM, Chungcheongnam-do (KR)

(21) Appl. No.: 17/901,610

(22) Filed: Sep. 1, 2022

(30) Foreign Application Priority Data
Aug. 9, 2022 (KR) 10-2022-0099423

(51) Int. Cl. H01Q 3/34; H01Q 3/26

(52) U.S. Cl. CPC H01Q 3/34; H01Q 3/267

(57) ABSTRACT

An integrated control method for a plurality of beamforming antennas, which controls a plurality of phase array antennas in an integrated manner, includes the steps of: rows and the number of columns of the plurality of phase array antennas; selecting manufacturer channel information of each of the plurality of phase array antennas; setting the number of bits of the selected manufacturer channel information of each phase array antenna; and setting a Serial Peripheral Interface (SPI) lane range of the selected manufacturer channel information of each phase array antenna.

### CROSS REFERENCE

This application claims the benefit of Korean Patent Application No. 10-2022-0099423 filed in the Korean Intellectual Property Office on 9 Aug. 2022, the entire contents of which are incorporated herein by reference.

### BACKGROUND

The present invention relates to an integrated control method for a plurality of beamforming antennas, and more particularly, to an integrated control method for a plurality of beamforming antennas, which can collect manufacturer channel information configured of address data, mode data, phase data, and attenuation data in a wireless communication system that employs a plurality of phase array antennas, and control phase array antennas of various beamforming methods in an integrated manner.

4G communication systems operating at 27.6 to 28.4 GHz are spotlighted to meet the demands for wireless data traffic that is increasing after commercialization of 4G communication systems. In the 5G communication systems, various beamforming methods such as analog beamforming, digital beamforming, hybrid beamforming, and the like are discussed in order to lower the loss in the path of radio waves in a very high frequency band and to increase the propagation distance of the radio waves.

In addition, in order to acquire more precise radar signals even in a radar system that detects frequency characteristics and a location unique to an object existing at a distance, various beamforming methods such as the analog beamforming, digital beamforming, hybrid beamforming, and the like described above are discussed.

These various beamforming methods are implemented by controlling the phase and attenuation of each of a plurality of phase array antennas, and when a beamforming method is employed in a wireless communication system or a radar system, beamforming is provided in a wide frequency band (e.g., 1 to 70 GHz).

However, since beamforming is provided in a wide frequency band (e.g., 1 to 70 GHz) in a wireless communication system or a radar system, which employs phase array antennas of various beamforming methods, such as analog beamforming, digital beamforming, hybrid beamforming, and the like, there is a problem in that it is difficult to control the beamforming antennas in an integrated manner.

The background art of the present invention is disclosed in Korean Patent Publication No. 10-2005-0113771.

### SUMMARY OF THE INVENTION

Therefore, the present invention has been made in view of the above problems, and it is an object of the present invention to provide an integrated control method for a plurality of beamforming antennas, which can collect manufacturer channel information configured of address data, mode data, phase data, and attenuation data in a wireless communication system that employs a plurality of phase array antennas, and control phase array antennas of various beamforming methods in an integrated manner.

The technical problems to be solved by the present invention are not limited to the technical problems mentioned above, and unmentioned other technical problems will be clearly understood by those skilled in the art from the following descriptions.

To accomplish the above object, according to one aspect of the present invention, there is provided an integrated control method for a plurality of beamforming antennas, which controls a plurality of phase array antennas in an integrated manner, the method comprising the steps of: setting array information configured of the number of rows and the number of columns of the plurality of phase array antennas; selecting manufacturer channel information of each of the plurality of phase array antennas; setting the number of bits of the selected manufacturer channel information of each phase array antenna; and setting a Serial Peripheral Interface (SPI) lane range of the selected manufacturer channel information of each phase array antenna.

In the integrated control method for a plurality of beamforming antennas according to an embodiment of the present invention, the manufacturer channel information of each of the plurality of phase array antennas may be configured of address data, mode data, phase data, and attenuation data.

In the integrated control method for a plurality of beamforming antennas according to an embodiment of the present invention, the mode data may include a first mode of receiving an elevation and an azimuth and correcting each channel of each phase array antenna, and a second mode of calibrating the channel of each phase array antenna.

The integrated control method for a plurality of beamforming antennas according to an embodiment of the present invention may further comprise the step of receiving, when the mode data is set to the first mode, the elevation and the azimuth, and correcting using a lookup table including correction values according to the elevation and the azimuth for each channel of each phase array antenna.

The integrated control method for a plurality of beamforming antennas according to an embodiment of the present invention may further comprise the step of transforming the phase data and the attenuation data among the manufacturer channel information, based on a correction value calculated using the elevation and the azimuth or correction values of the elevation and the azimuth according to the lookup table.

The integrated control method for a plurality of beamforming antennas according to an embodiment of the present invention may further comprise the step of outputting each of the transformed manufacturer channel information in a Serial Peripheral Interface (SPI) method.

In the integrated control method for a plurality of beamforming antennas according to an embodiment of the present invention, a Serial Peripheral Interface (SPI) output speed may be adjusted by synchronizing each of the transformed manufacturer channel information with a Serial Peripheral Interface (SPI) clock.

In the integrated control method for a plurality of beamforming antennas according to an embodiment of the present invention, each manufacturer channel information may be stored in non-volatile memory.

In the integrated control method for a plurality of beamforming antennas according to an embodiment of the present invention, each manufacturer channel information stored in the non-volatile memory may be added or deleted.

The integrated control method for a plurality of beamforming antennas according to an embodiment of the present invention may further comprise the step of receiving, when the mode data is set to the second mode, calibration data for each channel of each phase array antenna, and calibrating the channel of each phase array antenna.

### BRIEF DESCRIPTION OF THE DRAWING

FIG. 1 is a view for explaining an integrated control method for a plurality of beamforming antennas according to an embodiment of the present invention.

### DETAILED DESCRIPTION OF THE PREFERRED EMBODIMENT

The detailed description of the present invention described below will make a reference to the accompanying drawings that show specific embodiments in which the present invention can be practiced. These embodiments are described in sufficient detail so that those skilled in the art may practice the present invention. It should be understood that various embodiments of the present invention are different from each other, but do not need to be mutually exclusive.

For example, specific shapes, structures, and characteristics described herein may be embodied in other embodiments without departing from the spirit and scope of the invention in relation to an embodiment. In addition, it should be understood that the location or arrangement of individual components within each disclosed embodiment may be changed without departing from the spirit and scope of the present invention.

Accordingly, the detailed description described below is not intended to be taken in a limiting sense, and if properly described, the scope of the present invention is limited only by the appended claims, together with all the scopes equivalents to those in the claims.

An integrated control method for a plurality of beamforming antennas according to an embodiment of the present invention is for controlling a plurality of phase array antennas in an integrated manner. First, array information configured of the number of rows and the number of columns of the plurality of phase array antennas is set.

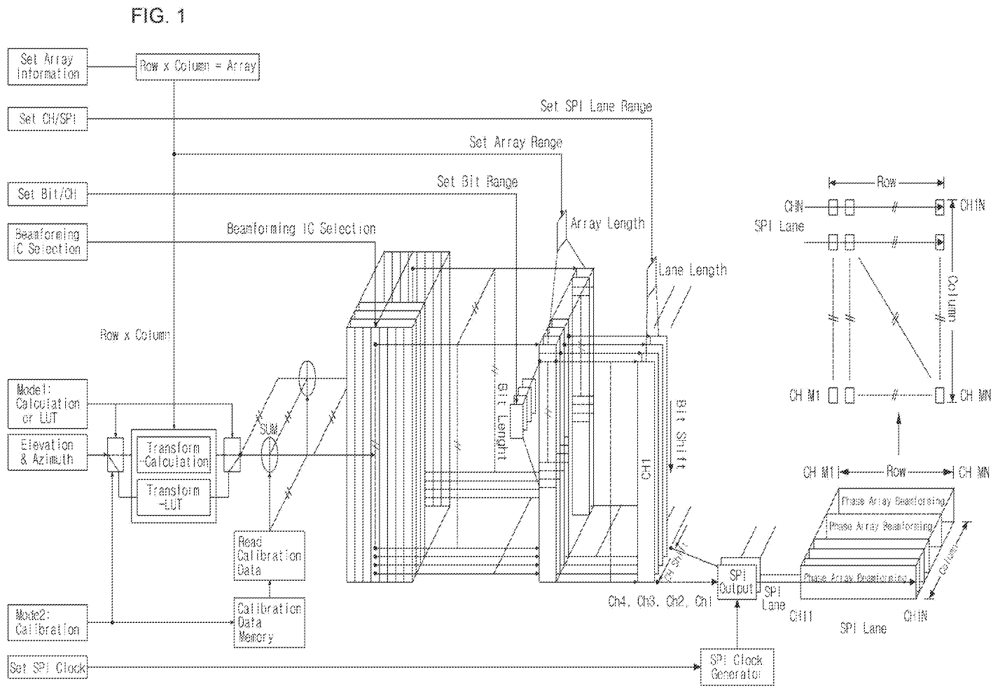

When the number of rows is set to M and the number of columns is set to N in a phase array antenna, the range of M*N phase array antenna is set as shown in FIG. 1.

Next, manufacturer channel information of each of the plurality of phase array antennas is selected. Here, the manufacturer channel information of each of the plurality of phase array antennas is configured of address data, mode data, phase data, and attenuation data, and the length of the manufacturer channel information may vary for each manufacturer.

Each manufacturer channel information is stored in non-volatile memory, such as EEPROM, flash memory, or the like, and may be read as needed to select manufacturer channel information. In addition, each manufacturer channel information stored in the non-volatile memory may be added or deleted.

Next, the number of bits of the selected manufacturer channel information of each phase array antenna is set. Since the length of the manufacturer channel information may vary for each manufacturer as described above, the number of bits is set according to the length of the selected manufacturer channel information.

Next, a Serial Peripheral Interface (SPI) lane range of the selected manufacturer channel information of each phase array antenna is set. That is, this is a process of setting the number of manufacturer channel information processed with one SPI (Serial Peripheral Interface) lane. As shown in FIG. 1, the Serial Peripheral Interface (SPI) lane range may be set according to the number of columns.

Here, the mode data includes a first mode of receiving an elevation and an azimuth and correcting the phase data and the attenuation data for each channel of each phase array antenna, and a second mode of calibrating the phase data and the attenuation data of the channel of each phase array antenna.

When the mode data is set to the first mode, the elevation and the azimuth are received, and the phase data and the attenuation data are calculated and corrected for each channel of each phase array antenna.

Specifically, as shown in FIG. 1, the elevation and the azimuth may be received, and then the phase data and the attenuation data are calculated and corrected for each channel of each phase array antenna.

On the other hand, the elevation and the azimuth are received, and then the phase data and the attenuation data are corrected using a lookup table including correction values of the phase data and the attenuation data according to the elevation and the azimuth for each channel of each phase array antenna.

Thereafter, the phase data and the attenuation data among the manufacturer channel information are transformed based on a correction value calculated using the elevation and the azimuth or correction values of the elevation and the azimuth according to the lookup table.

Next, each of the transformed manufacturer channel information is output in a Serial Peripheral Interface (SPI) method, and the Serial Peripheral Interface (SPI) output speed may be adjusted by synchronizing each of the transformed manufacturer channel information with a Serial Peripheral Interface (SPI) clock.

Meanwhile, when the mode data is set to the second mode, calibration data is received for each channel of each phase array antenna, and the phase data and the attenuation data of the channel of each phase array antenna are calibrated.

The integrated control method for a plurality of beamforming antennas according to an embodiment of the present invention may control phase array antennas of various beamforming methods in an integrated manner by collecting manufacturer channel information configured of address data, mode data, phase data, and attenuation data, selecting corresponding manufacturer channel information, setting the number of bits to match the length of the manufacturer channel information, and processing the manufacturer channel information in a Serial Peripheral Interface (SPI) method.

Although the present invention has been described and illustrated in connection with a preferred embodiment for illustrating the principles of the present invention, the present invention is not limited to the configuration and operation as shown and described above.

Rather, those skilled in the art will understand that many changes and modifications can be made to the present invention without departing from the spirit and scope of the appended claims.

Accordingly, all suitable changes and modifications and equivalents thereof should be considered as falling within the scope of the present invention.

The integrated control method for a plurality of beamforming antennas according to the embodiments of the present invention may collect manufacturer channel information configured of address data, mode data, phase data, and attenuation data in a wireless communication system that employs a plurality of phase array antennas, and control phase array antennas of various beamforming methods in an integrated manner.

What is claimed is:

1. An integrated control method for a plurality of beamforming antennas, which controls a plurality of phase array antennas in an integrated manner, the method comprising the steps of:
setting array information configured of the number of rows and the number of columns of the plurality of phase array antennas;
selecting manufacturer channel information of each of the plurality of phase array antennas;
setting the number of bits of the selected manufacturer channel information of each phase array antenna; and
setting a Serial Peripheral Interface (SPI) lane range of the selected manufacturer channel information of each phase array antenna.

2. The method according to claim 1, wherein the manufacturer channel information of each of the plurality of phase array antennas is configured of address data, mode data, phase data, and attenuation data.

3. The method according to claim 2, wherein the mode data includes a first mode of receiving an elevation and an azimuth and correcting each channel of each phase array antenna, and a second mode of calibrating the channel of each phase array antenna.

4. The method according to claim 3, further comprising the step of receiving, when the mode data is set to the first mode, the elevation and the azimuth, and calculating and correcting the phase data and the attenuation data for each channel of each phase array antenna.

5. The method according to claim 3, further comprising the step of receiving, when the mode data is set to the first mode, the elevation and the azimuth, and correcting the phase data and the attenuation data using a lookup table including correction values according to the elevation and the azimuth for each channel of each phase array antenna.

6. The method according to claim 4, further comprising the step of transforming the phase data and the attenuation data among the manufacturer channel information, based on a correction value calculated using the elevation and the azimuth or correction values of the elevation and the azimuth according to the lookup table.

7. The method according to claim 6, further comprising the step of outputting each of the transformed manufacturer channel information in a Serial Peripheral Interface (SPI) method.

8. The method according to claim 7, further comprising the step of adjusting a Serial Peripheral Interface (SPI) output speed by synchronizing each of the transformed manufacturer channel information with a Serial Peripheral Interface (SPI) clock.

9. The method according to claim 2, wherein each manufacturer channel information is stored in non-volatile memory.

10. The method according to claim 9, wherein each manufacturer channel information stored in the non-volatile memory is added or deleted.

11. The method according to claim 3, further comprising the step of receiving, when the mode data is set to the second mode, calibration data for each channel of each phase array antenna, and calibrating the channel of each phase array antenna.
